(19) United States
(12) Patent Application Publication
(10) Pub. No.: US 2026/0079508 A1
(43) Pub. Date: Mar. 19, 2026

(54) EXTRACTED PETROLEUM AND BIOFUEL FEEDSTOCK BLENDING APPARATUS AND METHOD OF USE THEREOF

(71) Applicants: Brian Cohen, San Juan Capistrano, CA (US); Daniel Robert Hideki Cohen, San Juan Capistrano, CA (US); Ryan Thomas Cohen, San Juan Capistrano, CA (US); W. Davis Lee, Rockport, ME (US); Mark Amato, S. Hamilton, MA (US); James W. McVay, Irvine, CA (US)

(72) Inventors: Brian Cohen, San Juan Capistrano, CA (US); Daniel Robert Hideki Cohen, San Juan Capistrano, CA (US); Ryan Thomas Cohen, San Juan Capistrano, CA (US); W. Davis Lee, Rockport, ME (US); Mark Amato, S. Hamilton, MA (US); James W. McVay, Irvine, CA (US)

(21) Appl. No.: 19/320,404

(22) Filed: Sep. 5, 2025

Related U.S. Application Data
(60) Provisional application No. 63/694,823, filed on Sep. 14, 2024.
(60) Provisional application No. 63/700,708, filed on Sep. 29, 2024.
(60) Provisional application No. 63/787,236, filed on Apr. 11, 2025.

(51) Int. Cl. G05D 21/02; G01N 29/04

(52) U.S. Cl. CPC G05D 21/02; G01N 29/04; G01N 2291/023

(57) ABSTRACT

A method for controlling a feedstock blend is described, comprising the steps of: measuring a corrosion of a pipe in a fuel processing facility with a sensor; setting a maximum sulfur content in the feedstock blend based on the corrosion; measuring a build-up of material in the pipe with the sensor; establishing a maximum viscosity of the feedstock blend based on output of the sensor; blending, to form the feedstock blend, a first feedstock and a second feedstock to fulfill both the maximum sulfur content and the maximum viscosity; and passing the feedstock blend through the first pipe.

### CROSS-REFERENCES TO RELATED APPLICATIONS

This application:
claims benefit of U.S. provisional patent application No. 63/787,236 filed Apr. 11, 2025;
claims benefit of U.S. provisional patent application No. 63/694,823 filed Sep. 14, 2024; and
claims benefit of U.S. provisional patent application No. 63/700,708 filed Sep. 29, 2024.

### BACKGROUND OF THE INVENTION

### Field of the Invention

The invention relates generally to processing, mixing, reacting, and/or blending various feedstocks, such as blending crude oil/extracted petroleum with one or more biofuels to form an oil product.

### DISCUSSION OF THE PRIOR ART

### Problem

There exists in the art a need for processing, mixing, reacting, and/or blending various feedstocks to form desired fuel products.

### SUMMARY OF THE INVENTION

The invention comprises a biofuel/extracted petroleum blending apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a controlled blending of feedstocks;

FIG. 2 illustrates blending feedstocks to yield desired chemical and/or physical properties.

FIG. 3 illustrates a pipe;

FIG. 4 illustrates wall thickness; and

FIG. 5 illustrates pipe corrosion.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises a controlled oil feedstock blending apparatus and method of use thereof that controls any one or more of feedstock(s), a transport/conditioning system, formation of blends, pre- and/or post-processing of feedstocks and/or blends, and/or production of the products, such as with a main controller. For example, a method for controlling a feedstock blend is described, comprising the steps of: measuring a corrosion of a pipe in a fuel processing facility with a sensor; setting a maximum sulfur content in the feedstock blend based on the corrosion; measuring a build-up of material in the pipe with the sensor; establishing a maximum viscosity of the feedstock blend based on output of the sensor; blending, to form the feedstock blend, a first feedstock and a second feedstock to fulfill both the maximum sulfur content and the maximum viscosity; and passing the feedstock blend through the first pipe.

Herein, crude oil refers to unrefined petroleum, such as oil from the ground or from layers under a ground surface, where petroleum refers to a mixture of hydrocarbons present in certain rock strata that can be extracted and refined to produce fuels, such as: gasoline, kerosene, diesel oil, and/or oil.

Herein, crude oil is also referred to as extracted petroleum, where the extracted petroleum is optionally subjected to any amount of preprocessing before being stored as a feedstock.

### Introduction

Co-processing of biogenic carbon with petroleum makes plant infrastructure vulnerable to a variety of corrosion mechanisms that are a function of fuel chemistry, temperature, and material of plant construction. Presently, to produce biodiesel products normal plant operation allows for 20% tallow to be blended with petroleum from the start of processing. There is strong interest in expanding the feed stock to include input streams of biocrude and to increase the percentage of biogenic carbon in the fuel product from 20% to as much as 100%. The primary challenge involved in making this process change is ensuring that plant infrastructure, originally designed for petroleum processing, is compatible with high concentrations of biogenic feedstocks. Therefore, there exists a need to actively monitor plant conditions and adjust the process parameters to optimize both product output and asset lifetime as a function of feedstock, which is addressed herein.

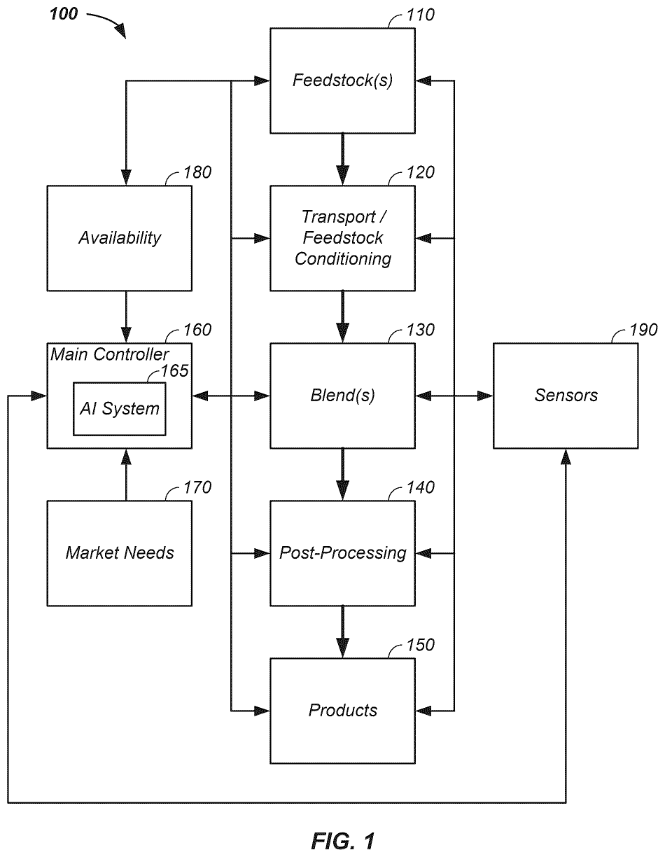

Referring now to FIG. 1, a controlled feedstock blending system 100 is illustrated. Generally, a plurality of feedstocks 110, which are preferably conditioned 120 and/or transported are blended to form one or more blends 130 subsequently used as and/or in a product 150. The blends 130 and/or the feedstocks 110 are optionally and preferably post-processing 140, such as to add one or more additives and/or stabilizers and/or to break chemical bonds to form shorter carbon chains. The controlled feedstock blending system 100 is further described, infra.

Still referring to FIG. 1, a main controller 160 controls any one or more of the feedstock(s) 100, transport/conditioning system 120, formation of the blends 130, the post-processing 140, and/or production of the products 150. Generally, the main controller 160 is optionally and preferably fed inputs of market needs 170, availability 180 of the various feedstocks 110, and/or data/readings/information from sensors 190, which are optionally and preferably connected to any system/container/element of the controlled feedstock blending system 100, such as any element of the feedstock container and/or elements therein, any transport system, any feedstock conditioning system, any blending system/blending apparatus, any monitoring of the produced blends, any pre-and/or post-processing of any of the processed materials or elements used in the processing, and/or any element associated with production of the products. Generally, the sensors provide input to the main controller and/or an artificial intelligence 165 system thereof for control of the feedstock blending system 100.

Still referring to FIG. 1, the sensors 190 optionally and preferably comprise an array of sensors monitoring any one or more of: temperatures, such as of a feedstock storage unit, a transport pipe, a mixing container, and/or a local environment; any pipe property, such as a pipe thickness, a measure of pipe corrosion, and/or a measure of pipe clogging/blockage; a volume of any element described herein; a flowrate of any element described herein; a link to a news/information source, such as monitoring market prices/projections; any chemical property of any of the feedstocks and/or any resulting blend thereof; and/or any physical property of any of the feedstocks and/or any resulting blend thereof. The sensors are further described infra.

### Feedstocks/Blends

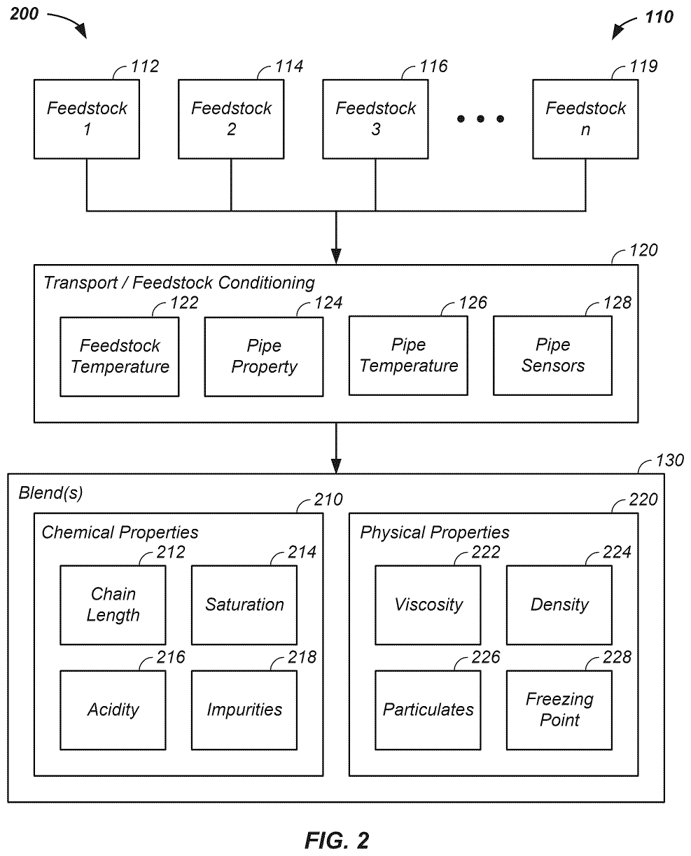

Referring now to FIG. 2, the feedstocks 110 are further described. Generally, there are n feedstocks contained in n containers, where n is a positive integer greater than 1, 2, 3, 4, 5, 6, 7, 8, 10, 15, or 20. For instance, there is a first feedstock 112, a second feedstock 114, a third feedstock 116, . . . , and an n^{th} feedstock 119. Generally, each feedstock 110 is a separate oil, oil blend, fat source, and/or liquid, where each feedstock has it's own chemical and/or physical properties. The feedstocks 110 are optionally and preferably stored in any size container, such as greater with a capacity of greater than 50, 100, 1000, or 10,000 barrels per container. For clarity of presentation, several examples of feedstocks are provided.

### Example I

In a first example, the first feedstock 112 comprises beef tallow. Beef tallow has chemical properties that vary, but are generally in a range, such as measured by any of the sensors 190 described supra. For instance, beef tallow is a rendered form of beef fat and has a chemical composition largely based on a fatty acid profile. Generally, the fatty acids of beef tallow are primarily composed of triglycerides, which are esters formed from glycerol and three fatty acids. Beef tallow has a saturated/unsaturated fat profile, where saturated fats have no double bonds between the carbon atoms in their fatty acid chains. Beef tallow is primarily comprised of saturated fats, such as stearic acid, with a C18 chain length, and palmitic acid, with a C16 chain length. Beef tallow does contain a smaller amount of unsaturated fat, such as from oleic acid, which has a C18 chain length of 18 carbons with one double bond in its fatty acid chain, linoleic acid, which has a C18 chain and two double bonds, and alpha-linolenic acid, which has a C18 chain length and three double bonds. The point is that the first feedstock 112 optionally and preferably has a known chemical profile, which in this example is rich in saturated fats with smaller amounts of monounsaturated and polyunsaturated fats.

### Example II

In a second example, the second feedstock 114 comprises corn oil. Corn oil, which is derived from the germ of corn kernels, has specific chemical properties. Corn oil has a fatty acid composition that is rich in polyunsaturated fatty acids. Particularly, corn oil is rich in the polyunsaturated fat of linoleic acid, an omega-6 fatty acid, which constitutes about 55-60% of corn oil; contains 25-30% monounsaturated fatty acids, such as oleic acid, an omega-9 fatty acid; and contains a relatively low 10-13% of saturated fatty acids, primarily palmitic and stearic acid. The point is that the second feedstock 114 optionally and preferably has a known chemical profile, which in this example is rich in polyunsaturated fats, has substantial amount of monounsaturated fats, and a low measure of saturated fats.

Still referring to FIG. 2, blends 130 are further described. In this example, provided for clarity of presentation and without loss of generality, any amount of the first feedstock 112 and the second feedstock 114, such as described in Examples I and II supra, are optionally blended to form a blended oil product. Thus, using the first and second example feedstocks, described supra, the resulting blend optionally is optionally prepared with any ratio of polyunsaturated, monounsaturated, and saturated fatty acids by controlling a relative measure of the first and second feedstocks.

Naturally, different types of vegetable oils, such as canola, olive, sunflower, soybean, corn, safflower, peanut, sesame, grapeseed, avocado, flaxseed, hemp, and coconut oil contain differing chemical and/or physical properties. For instance, each vegetable oil, optionally and preferably provided as separate feedstocks, also contain individual properties, such as a smoke point, an oxidative stability, a flavor, an aroma, a chemical structure, an iodine value, a refractive index, and/or a composition of minor components, such as measures of tocopherols and/or phytosterols. Thus, by mixing in the blend 130, any ratio of the individual feedstocks, any blend of individual properties is achieved.

### Example III

In a third example, the third feedstock 116 is optionally any extracted petroleum. Examples of extracted petroleum vary widely, but each source/bin of extracted petroleum has a chemical and physical profile that is known and/or is measurable, such as with the sensors 190. For instance, the carbon length of extracted petroleum varies from a very short carbon chain, such as for methane, ethane, and propane, to mid-chain length, like the vegetable oils, to long paraffin chains. In addition, the extracted petroleum can contain measures of cycloalkanes, aromatics, asphaltenes. Further, extracted petroleum can contain non-hydrocarbons, such as sulfur compounds including hydrogen sulfide, mercaptans, thiols, and/or nitrogen compounds, such as pyridine and quinolines.

As described above, a blend of the extracted petroleum, as a third feedstock, with one or more of the vegetable oils, such as in the second feedstock, is optionally used to form any mix in a resultant blend. Particularly useful is a dilution of any harmful non-hydrocarbon concentrations, of the extracted petroleum feedstock, down to legally and/or environmentally acceptable levels through dilution with the beef tallow feedstock and/or the vegetable oil feedstock.

Similarly, the extracted petroleums, optionally and preferably stored in separate/additional feedstock containers have additional physical parameters that vary between sources and/or from a single source as a function of time, such as density, viscosity, freezing range, and/or boiling range. Taking viscosity as an example, viscosities vary from very thin light fluid to very heavy and sticky, depending on the composition of the extracted petroleum. Thus, as above, any physical property, such as viscosity, is optionally controlled in the blending process. Viscosity control of the feedstocks is further described, infra.

### Transport/Feedstock Conditioning

Referring again to FIG. 2, the transport/feedstock conditioning system 120 is further described. Generally, each feedstock has its own physical properties, such as described supra. Herein, for clarity of presentation and without loss of generality, viscosity is used as an example of a feedstock state. A beef tallow feedstock is quite viscous, while a sunflower oil feedstock is not as viscous. Thus, in the transport/feedstock conditioning system 120, the beef tallow feedstock container is optionally heated, which reduces the viscosity of the beef tallow and/or feedlines from a beef tallow holding container to a blending container are optionally and preferably heated, which allows the lower viscosity heated beef tallow to flow more readily. Thus, in the transport/feedstock conditioning system, the pipe sensors 128 are optionally used to monitor/control the feedstock container, a feedstock delivery pipe/delivery pipe 126, and or a blending container. Similarly, the pipe sensors 128 are used to measure state of the pipe and/or any property of any element transported by the pipe. Examples of monitored/controlled pipe properties 124 include a pipe wall thickness, a pipe history, a pipe flow rate, a measure of pipe clogging, and/or a measure of pipe wall corrosion, such as a function of time. Optionally, the state of the transported element is changed with an additive.

Still referring to FIG. 1 and FIG. 2, time of acidic and/or caustic elements in the pipes, of the feedstock blending system 100, are optimized to low/minimum time lengths by the main controller 160 to minimize damage to elements of the plant. Similarly, the main controller 160 is optionally and preferably used to maintain necessary temperatures for viscosity/flow rate concerns, but again to maintain lower temperatures when possible to reduce heating costs and especially to reduce corrosion, where elevated temperatures exacerbate damage from acidic, caustic, and/or chemical reactions, which damage pipes.

### Sensors

Referring again to FIG. 1 and FIG. 2, for clarity of presentation and without loss of generality, the sensors 190, such as the pipe sensors 128 and/or sensors monitoring the feedstock(s), blends 130, a processing step 140, and/or a product 150, optionally measure, for any of the fats/oils presented herein, any one or more of: (1) chemical properties 210, such as any measure of chemical chain length 212, any measure of fat saturation 214, any measure of acidity 216, causticity, and/or pH, and/or any chemical impurity, such as a measure of any form of sulfur and/or (2) physical properties 220, such as viscosity 222, density 224, a measure of any physical particulate 226, and/or a phase change point, such as a freezing point 228, a transition point, and/or a boiling point 228.

### Pipe Management

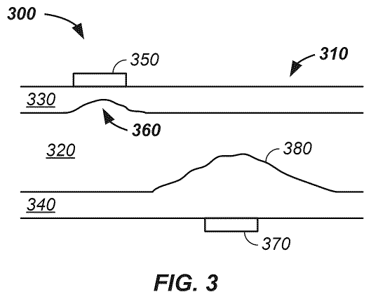

Referring now to FIG. 3, in the controlled feedstock blending system 100, a pipe control management system 300 of a pipe 310 is illustrated. As illustrated, the pipe 310 has a central opening 320 therethrough between a first wall 330 and a second wall 340. A first sensor 350, such as a corrosion sensor, is illustrated sensing a first corrosion zone 360 and a second sensor 370, such as a build-up sensor, is illustrated sensing a first build-up zone 380. The sensors are optionally ultrasonic sensors. The corrosion zone 360 and the build up zone 380 are illustrated at 50%, respectively; however the build-up and/or the corrosion is optionally greater than 1, 2, 5, 10, 20, 25, 30, 40, 50, 60, 70, 75, 80, or 90 percent of the pipe opening 380 or the wall thickness, respectively. Generally, any number of sensors sensing any number of pipe parameters are used to determine how a biofuel passing through the pipe should be blended. Two examples, provided for clarity of presentation and without loss of generality are provided, infra.

### Example I

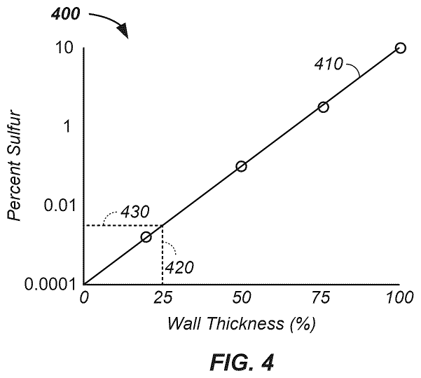

Referring still to FIG. 3 and referring now to FIG. 4, the wall thickness corrosion is further described. As illustrated, the remaining wall thickness relative to a 100% thick uncorroded wall thickness, which is a measure of corrosion of the pipe 310, is plotted on the x-axis. A percent sulfur, such as in a blended feedstock, is on the y-axis, where the fit is optionally and preferably from prior research, is a result of an equation, is tabulated, and/or is in a look-up table. For a measured wall thickness 420, a maximum percent sulfur 430/a first threshold in the blended feedstock is illustrated. As illustrated, the wall thickness is only twenty-five percent of an uncorroded wall thickness, which indicates that the pipe 310 is highly corroded. Sulfur leads to sulfuric acid, which is corrosive. As such, a relatively small percent sulfur of 0.005% is set as a maximum sulfur concentration in a blended biofuel. Similarly, if the first sensor 350 indicated a more intact wall/a larger percent wall thickness, then the percent sulfur in the blended feedstock would be correspondingly higher, such as greater than 0.01, 0.1, 1, or 5 percent.

### Example II

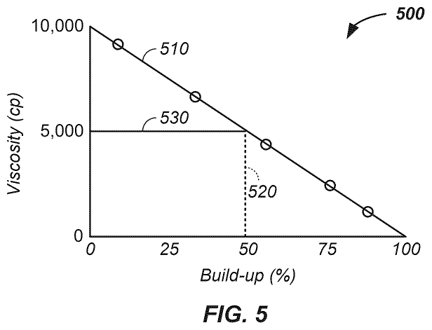

Referring still to FIG. 3 and referring now to FIG. 5, the build-up is further described. As illustrated, the build-up relative to a 100% blockage of the opening 320 of the pipe 310, is plotted on the x-axis. A viscosity, such as in a blended feedstock, is on the y-axis, where the fit is optionally and preferably from prior research, is a result of an equation, is tabulated, and/or is in a look-up table. For a measured build-up 520, a maximum viscosity 530/a second threshold in the blended feedstock is illustrated. As illustrated, the build-up is fifty percent of a total diameter of the opening 320, which indicates that the pipe 310 is pretty blocked. A lower viscosity blended biofuel results in lower pressure in the pipe. As such, as illustrated, the maximum viscosity of the blended biofuel in this case is set to 5,000 cp. Similarly, if the second sensor 370 indicated a smaller blockage, then the tolerable viscosity would be lower, such as less than 10,000, 9000, 8000, 7000, or 6000 cp.

In both examples provided supra, the sulfur percent and the viscosity relative to the x-axis values are merely illustrative and any calibration curve is optionally used.

### AI System

Any inputs, sensor reading, output, and/or human decision in operating the feedstock blending system 100 is optionally and preferably recorded for use in training the artificial intelligence (AI) system 165.

### Main Controller

A dynamic feedstock calculator, an optional element of the main controller 160, is a tool designed to evaluate and optimize the use of various raw materials (feedstocks) in the production of products, such as biofuels or chemicals. In the context of biofuel production, such as from algae or other biomass, the dynamic feedstock calculator dynamically assesses the quantity and quality of feedstock needed to meet production targets, considering variables such as: the changing characteristics of feedstock, such as moisture content, energy value, and composition, which can vary seasonally or due to source variation. The dynamic feedstock calculator adjusts to the production goals, scaling the feedstock requirements up or down based on the desired output volume of biofuel or other products. The dynamic feedstock calculator accounts for changes in the efficiency of the conversion process, which can be affected by technological upgrades, process improvements, or varying feedstock characteristics. The tool can integrate cost data, including the price of acquiring different feedstocks, processing costs, and market prices of the end products, to optimize for economic efficiency and optionally and preferably considers the environmental footprint of using different feedstocks, helping to choose options that minimize carbon emissions, water usage, or waste production. The dynamic feedstock calculator optionally and preferably factors in logistical aspects, such as the availability and transport costs of feedstock, storage requirements, and supply chain reliability.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for controlling a feedstock blend, comprising the steps of:
measuring a first parameter of a pipe in a fuel processing facility with a first sensor;
establishing a first threshold based on output of said first sensor;
measuring a second parameter of said pipe with a second sensor;
establishing a second threshold based on output of said second sensor;
blending, to form the feedstock blend, a first feedstock and a second feedstock to fulfill both said first threshold and said second threshold; and
passing the feedstock blend through said first pipe.

2. The method of claim 1, further comprising the steps of:
measuring a corrosion of a pipe with said first sensor; and
setting a maximum sulfur content in the feedstock blend based on said first threshold.

3. The method of claim 1, further comprising the step of:
using a first ultrasonic sensor as said first sensor.

4. The method of claim 1, further comprising the steps of:
measuring a build-up within said pipe with a second sensor; and
setting a maximum viscosity of the feedstock blend based on said second threshold.

5. The method of claim 4, further comprising the step of:
using said first ultrasonic sensor as said second sensor.

6. The method of claim 1, further comprising the steps of:
measuring a corrosion of a pipe with said first sensor;
setting a maximum sulfur content in the feedstock blend based on said first threshold;
measuring a build-up within said pipe with a second sensor;
setting a maximum viscosity of the feedstock blend based on said second threshold.
using an ultrasonic sensor as said first sensor.

7. A method for controlling a feedstock blend, comprising the steps of:
measuring a corrosion of a pipe in a fuel processing facility with a sensor;
setting a maximum sulfur content in the feedstock blend based on said corrosion;
measuring a build-up of material in said pipe with said sensor;
establishing a maximum viscosity of the feedstock blend based on output of said sensor;
blending, to form the feedstock blend, a first feedstock and a second feedstock to fulfill both said maximum sulfur content and said maximum viscosity; and
passing the feedstock blend through said first pipe.
